(19) United States
(12) Patent Application Publication
(10) Pub. No.: US 2011/0125324 A1
(43) Pub. Date: May 26, 2011

(54) ROBOT CLEANER AND CONTROLLING METHOD OF THE SAME

(76) Inventors: Sanghoon BAEK, Pohang (KR); Jeongsuk Yoon, Seoul (KR); Seungmin Baek, Seoul (KR); Sangik Na, Seoul (KR); Kwangro Joo, Pohang (KR); Tae-Kyeong Lee, Pohang (KR); Se-Young Oh, Pohang (KR); Donghoon Yi, Seoul (KR); Taegon Park, Seoul (KR)

(21) Appl. No.: 12/949,923

(22) Filed: Nov. 19, 2010

(30) Foreign Application Priority Data
Nov. 20, 2009 (KR) 10-2009-0112871

(51) Int. Cl. G05B 15/00; G06F 19/00

(52) U.S. Cl. 700/258; 700/245

(57) ABSTRACT

A robot cleaner and a method of controlling a robot cleaner are provided. The robot cleaner is capable of automatically compensating for and adjusting a moving angle and a position using an appropriate sensor and control algorithm while performing a cleaning operation in a relatively large space. This may reduce a position error, allow a cleaning region to be effectively identified as a region to be cleaned or a region having already been cleaned, thus improving cleaning performance and efficiency.

### CROSS-REFERENCE TO RELATED APPLICATION(S)

Pursuant to 35 U.S.C. §119(a), this application claims the benefit of earlier filing date and right of priority to Korean Application No. 10-2009-0112871, filed in Korea on Nov. 20, 2009, the content of which is incorporated by reference herein in its entirety.

### BACKGROUND

1. Field

The present invention relates to a robot cleaner, and a controlling method of the same.

2. Background

Generally, robots have been developed for use in industrial applications, in factory automation, and have been adapted for use in various fields, such as medical robots, space robots, home robots, and other such applications.

### BRIEF DESCRIPTION OF THE DRAWINGS

The embodiments will be described in detail with reference to the following drawings in which like reference numerals refer to like elements wherein:

FIG. 1 is a perspective view of a robot cleaner in accordance with an embodiment as broadly described herein;

FIG. 2 is a block diagram of the robot cleaner shown in FIG. 1;

FIGS. 3 and 4 are flowcharts of a controlling method of a robot cleaner in accordance with embodiments as broadly described herein;

FIG. 5 is a plan view of the robot cleaner including a position recognition device as embodied and broadly described herein;

FIGS. 6 to 8 illustrate an operation in which the robot cleaner is searching for a wall surface, in accordance with a method as embodied and broadly described herein;

FIGS. 9 and 10 illustrate an operation in which the robot cleaner is compensating for a moving angle, in accordance with a method as embodied and broadly described herein;

FIGS. 11 and 12 illustrate an operation in which the robot cleaner is setting sectors on a cleaning region, in accordance with a method as embodied and broadly described herein;

FIGS. 13 to 19 illustrate an operation in which the robot cleaner is determining a sector type, in accordance with a method as embodied and broadly described herein;

FIGS. 20 to 23 illustrate an operation in which the robot cleaner is setting a sector reference point, in accordance with a method as embodied and broadly described herein;

FIGS. 24 to 26 illustrate an operation in which the robot cleaner is cleaning a sector in accordance with embodiments as broadly described herein; and

FIGS. 27 to 30 illustrate an operation in which the robot cleaner is determining whether a cleaning operation has been completed, in accordance with embodiments as broadly described herein.

### DETAILED DESCRIPTION

A home robot may be a kind of home electronic appliance capable of performing a cleaning operation, such as, for example, vacuuming, while autonomously moving on a predetermined region. Such a robot cleaner may have a chargeable battery and an obstacle sensor for avoiding obstacles while moving.

In order for the robot cleaner to clean all regions while autonomously moving, a cleaning map may be made, and a cleaning region on the cleaning map may be categorized into regions to be cleaned or regions having already been cleaned. This determination may be performed by a precise position recognition operation carried out by the robot cleaner.

The robot cleaner may be operated using numerous different methods. For example, when operating under a random method, the robot cleaner may easily avoid obstacles and may move arbitrary distances in arbitrary directions to accomplish cleaning of a given region. However, if the region to be cleaned is relatively large, a corresponding cleaning coverage ratio using the random method may be relatively low, and it may take a relatively long time to finish cleaning. The cleaning coverage ratio may represent, for example, a rate, or a proportion, of a cleaned area or range to an overall area or range to be cleaned.

When operating under a spiral method, the robot cleaner may move in an increasing rotation radius by continuously rotating in a predetermined direction from a starting point. This may enhance the cleaning coverage ratio compared to that of the random method, and may more easily clean a specific region. However, the spiral method may not be as effective in cleaning a room having a quadrangular shape, and thus cleaning performance may be affected.

When operating under a zigzag method, the robot cleaner may run along straight lines in a repetitive manner, along a long path and a short path, allowing the robot cleaner to more easily clean a room having a quadrangular shape, and provide a relatively high cleaning coverage ratio compared to that of the random and spiral methods. However, in the zigzag method, cleaning performance may be degraded based on, for example, the presence of obstacles. Thus, in all three moving methods of the robot cleaner, cleaning performance and cleaning efficiency may be degraded based on an environment in which the robot cleaner is to operate.

The robot cleaner may be equipped with a distance sensor to detect its peripheral environment, such as, for example, confines of the space to be cleaned and/or obstacles therein, to set coordinate values with respect to the space to be cleaned based on detected information, and/or to divide the space into a plurality of sectors and then to perform a cleaning operation. This may provide enhanced cleaning performance with respect to a closed space. However, when cleaning an entire region inside a house, the robot cleaner may still have lowered cleaning performance or cleaning efficiency due to, for example, differences in the spaces to be cleaned and other elements of its peripheral environment.

Furthermore, depending on the quality and capability of the position recognition sensor, position recognition error may accumulate/become larger over time, thus lowering cleaning performance and cleaning efficiency when a cleaning region is relatively large.

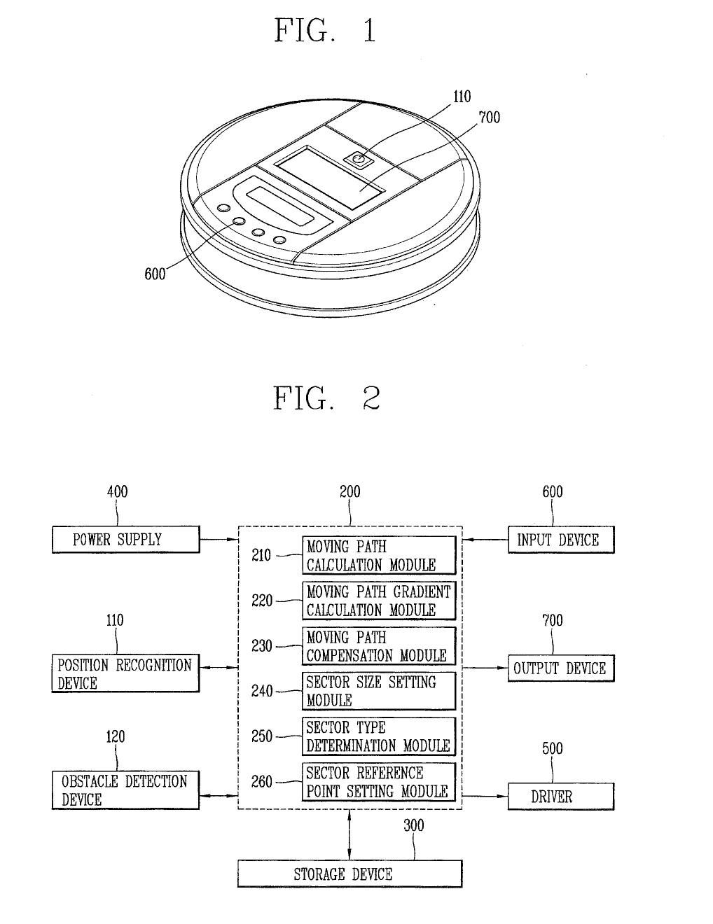

As shown in FIGS. 1 and 2, a robot cleaner as embodied and broadly described herein may include a position recognition or detection device 110 having one or more distance sensors that recognize a position of the robot cleaner within a cleaning region, and a controller 200 configured to divide the cleaning region into a plurality of sectors, to compensate for a moving angle of the robot cleaner based on its moving path, and to correct the position of the robot cleaner based on the moving path and the moving angle.

A power supply 400 may include a chargeable power supply means to supply power to the robot cleaner, and a driver 500 may drive one or more wheels to move the robot cleaner. The position recognition device 110 may include one or more distance sensors to recognize a position of the robot cleaner within a cleaning region, and the controller 200 may compensate for the position by calculating a moving path, and may perform a cleaning operation by setting sectors for movement within the cleaning region. The power supply 400 may supply power required for the robot cleaner to move and perform a cleaning operation. If an amount of battery power provided in the power supply 400 is insufficient, a current may be supplied from, for example, a charging plate or other appropriate source. The driver 500 may drive a wheel motor for rotating a plurality of main wheels and one or more supplementary wheels, thereby moving the robot cleaner.

The controller 200 may include a moving path calculation module 210 configured to extract moving points collected during a predetermined period, and to calculate the moving path by connecting the moving points to each other. The controller 200 may also include a moving path gradient calculation module 220 configured to calculate a gradient of an initial moving path by connecting a predetermined number of moving points to each other, and to calculate a gradient change of the moving path based on a position of a next moving point and the gradient of the initial moving path. The controller 200 may also include a moving angle compensation module 230 configured to compensate for a moving angle of the robot cleaner based on changes of the gradient of the moving path. The controller 200 extracts moving points collected during the predetermined period, and calculates the moving path based on the moving points. The controller 200 then calculates a gradient of an initial moving path by connecting the predetermined number of moving points to each other, and calculates a gradient change of the moving path based on a position of a next moving point and the gradient of the initial moving path.

Hereinafter, an operation to compensate for a moving angle of the robot cleaner will be explained with reference to FIGS. 9 and 10. FIG. 9 illustrates an operation in which the controller 200 calculates a moving path as the robot cleaner searches for a wall surface. That is, when the robot cleaner moves along a wall surface, the controller 200 extracts a finite number (n) of moving points P at prescribed intervals Pᵢₙₜ. Then, the controller 200 calculates an initial moving path B_{w} based on the moving points. The controller 200 calculates a gradient of the initial moving path, and stores the moving points and the moving path in a storage device 300. If a new moving point is added, the controller 200 calculates the moving path again, and determines whether the newly added moving point should be included in the previous moving path, or whether a new moving path should be calculated based on the newly added moving point. This may be determined based on a distance dₚ₋₁ between the added moving point and the moving path, and based on an angle θₚ₋₁ between the added moving point and a center point of the moving path. The controller 200 may utilize a gradient of the calculated moving path as a reference angle for compensating for a moving angle.

FIG. 10 illustrates an operation for substantially compensating for a moving angle based on the moving path calculated in FIG. 9. FIG. 10 illustrates an operation in which moving paths in two sectors are compared and compensated. In FIG. 10, dθ refers to a difference between an angle of a moving path in one sector and another moving path in another sector, dx refers to a distance along the x-axis (coordinates) between two moving paths in parallel, and dy refers to a distance along the y-axis between two paths in parallel.

If a currently calculated moving path is determined to be disposed on essentially the same line as a moving path calculated from a previous sector, the controller 200 compensates for the currently calculated moving path into the moving path of a previous sector. Then, the controller 200 utilizes this compensated moving path as a reference angle for compensating for a moving angle of a next sector.

For example, when the robot cleaner encounters an obstacle, the robot cleaner senses or detects the obstacle, and a position of the robot cleaner at the point where the robot cleaner senses or detects the obstacle becomes a moving point. As the robot cleaner moves along its initial moving path, whenever the robot cleaner collects new moving point, the last moving point (or central point) of the initial moving path along which it is moving, is connected to the newly collected moving point to define a new line. The slope of the newly defined line is compared to the slope of the initial moving path, and an angle error is calculated. Using the calculated angle error, the robot cleaner compensates for the angle error, and determines new moving path.

Referring back to FIG. 2, the controller 200 may include a sector size setting module 240 configured to set a sector size based on an initial sector size and an overlapping margin with a neighboring sector. The controller 200 may also include a sector type determination module 250 configured to determine a sector type according to an initial sector size and an obstacle detected within the cleaning region, and a sector reference point setting module 260 configured to set a sector reference point, and an initial sector position according to the determined sector type.

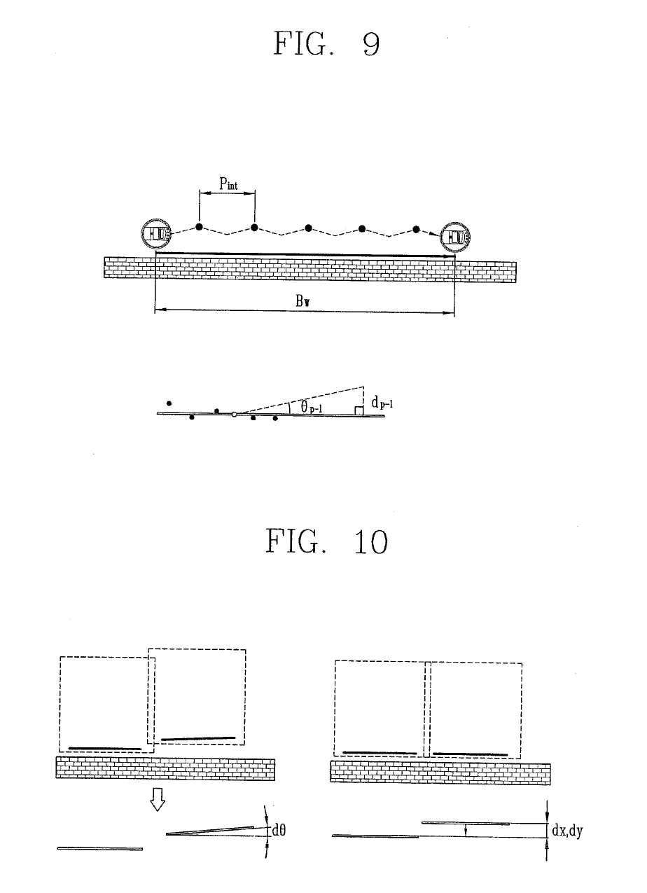

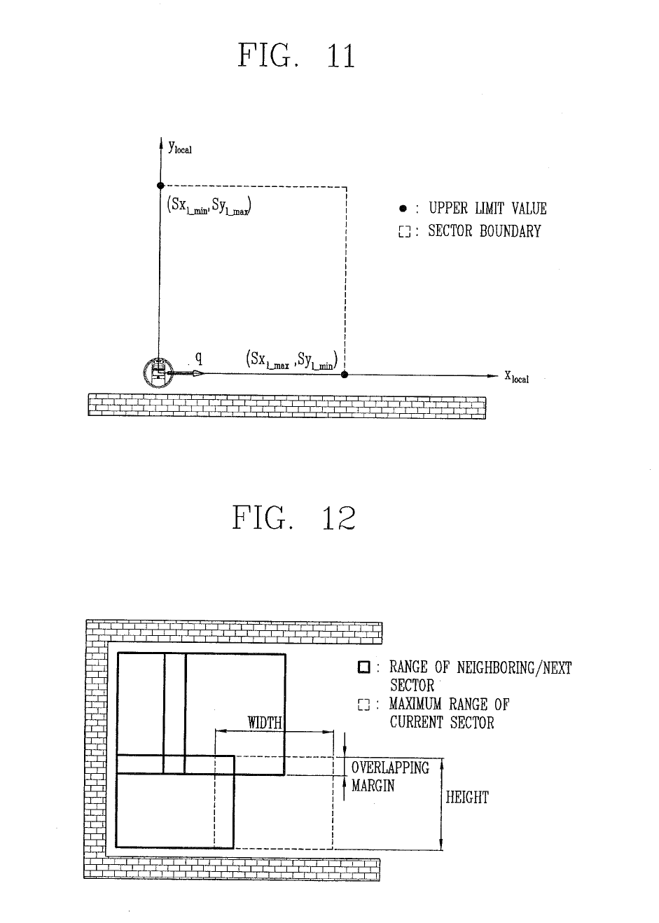

An operation for setting a sector will be explained with reference to FIGS. 11 and 12. FIG. 11 illustrates an operation for setting a sector reference point so as to perform a cleaning operation on divided sectors. The sector reference point may include two components, a position (x, y) and a direction (q). FIG. 12 illustrates an operation for setting a size of a sector, i.e., a maximum range of a sector. The controller 200 sets an initial sector range based on an initial size of a sector, i.e., a height and a width. Then, the controller 200 determines a height and a width of the sector based on an overlapping margin with a neighboring sector, thereby re-setting a size of the sector.

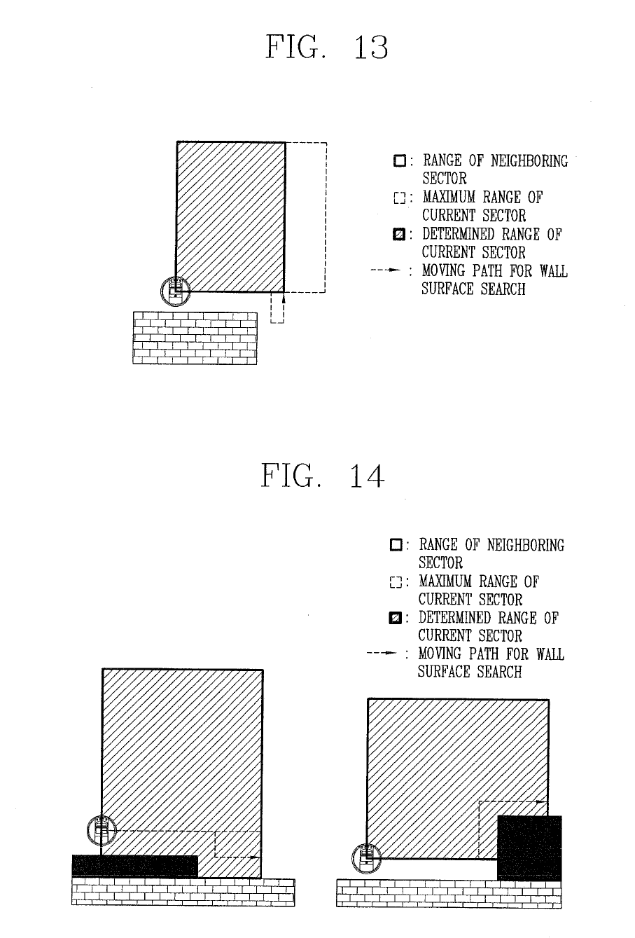

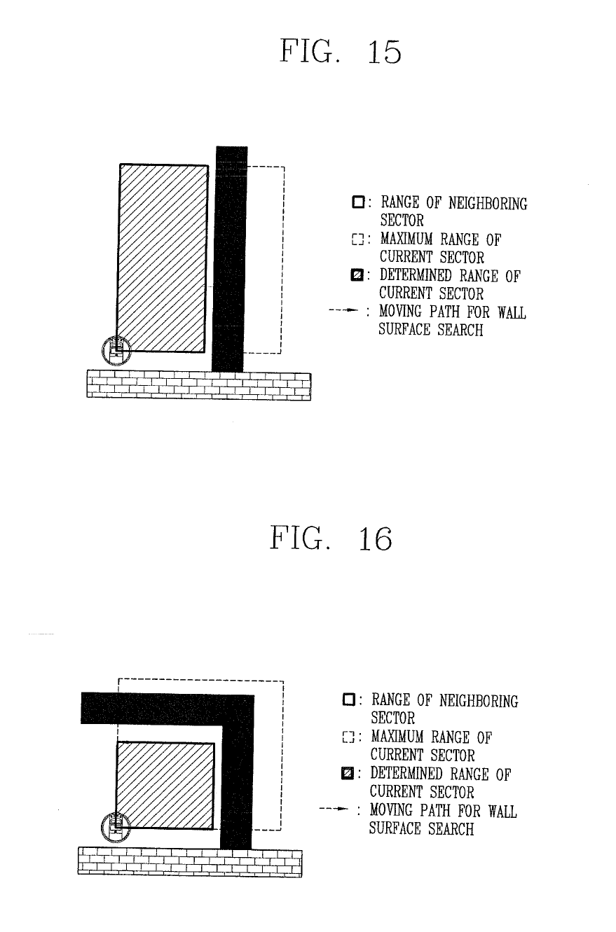

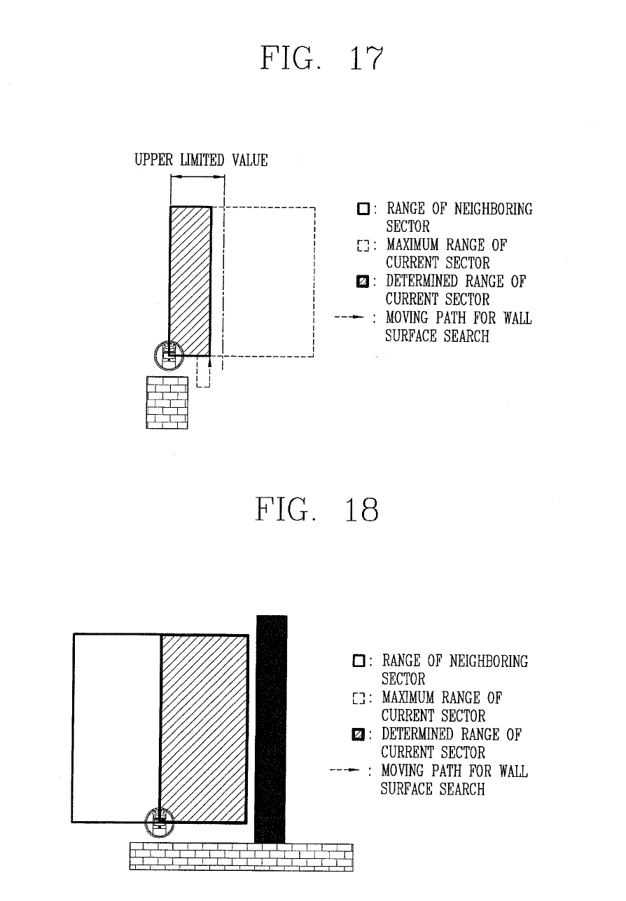

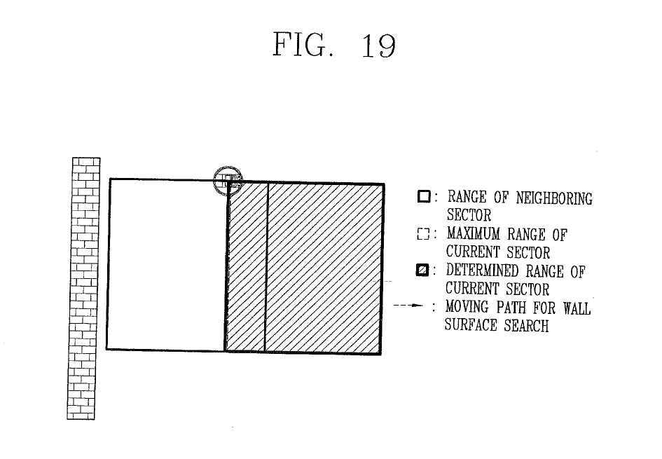

An operation for determining a type of a sector will be explained with reference to FIGS. 13 to 19. The controller 200 determines a sector type based on an upper limited value at a boundary between an initial size and a maximum size of a predetermined sector while the robot cleaner searches for a wall surface. And, the controller 20 may determine a sector type based on information on a detected obstacle. That is, the controller 200 determines a type of a sector by forming a closed section along the boundary by changing a direction if the robot cleaner, which is searching for a wall surface, exceeds a preset range. Alternatively, the controller 200 may determine a type of a next sector by forming a closed section by changing a direction if the robot cleaner detects an obstacle, such as a new wall surface, within the preset range.

As shown in FIGS. 13 to 19, a sector type may be categorized into an Open Type (I) which may encompass a part of a maximum range, a Normal Type which may encompass a maximum range with a small number of obstacles, a Blocked Type (I) which may be diminished in range due to interference of an obstacle in one direction, a Blocked Type (II) which may be diminished in range due to interference of obstacle(s) in more than two directions, an Open Type (II) which may have a smaller or restricted range compared to the Open Type (I), a Within Type which may be included within another sector, and an Island Type which may overlap with another sector, respectively. Referring to FIGS. 13 to 16, if a sector size is smaller than a predetermined reference value, the sector may be further considered a small type. In the case of a small type, a within type, etc. a cleaning operation may not be required since it has a size requiring no cleaning or it has been already cleaned.

After determining a sector type, as shown in FIGS. 20 to 23, the controller 200 sets a sector reference point according to the sector type. If the current sector has an open type or a small open type, the controller 200 sets a direction angle of a reference point of the next sector by subtracting 90° from a direction angle of a reference point of the current sector. If the current sector has a normal type or a small normal type, the controller 200 sets the direction angle of the reference point of the next sector to be the same as that of the current sector. If the current sector has a blocked type (I) or a small blocked type (I), the controller 200 sets the direction angle of the reference point of the next sector by adding 90° to the direction angle of the reference point of the current sector. If the current sector has a blocked type (II) or a small blocked type (II), the controller 200 sets the direction angle of the reference point of the next sector by adding 180° to the direction angle of the reference point of the current sector.

The controller 200 determines a sector type, and sets a sector reference point, thereby dividing the cleaning region into a plurality of sectors. As shown in FIGS. 24 to 26, the robot cleaner performs a cleaning operation on the divided sectors. That is, while the robot cleaner moves along an outer periphery of a sector, the controller 200 determines a cleaning region inside the sector, and sets the cleaning region into a plurality of rectangular sub-sectors. Then, the controller 200 controls the robot cleaner to clean the sub-sectors according to a cleaning pattern using, for example, the zigzag method. Once the robot cleaner has completed cleaning the current sector, the controller 200 searches for a neighboring sector that has not yet been cleaned. Then, the controller 200 moves the robot cleaner to a starting point of the neighboring sector, i.e., a reference point, and starts to clean the corresponding sector.

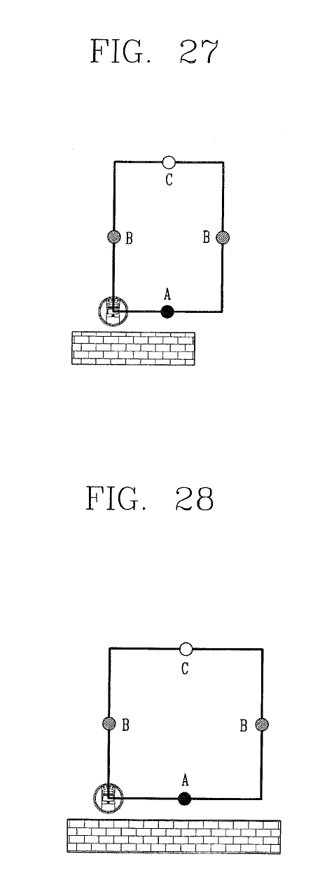

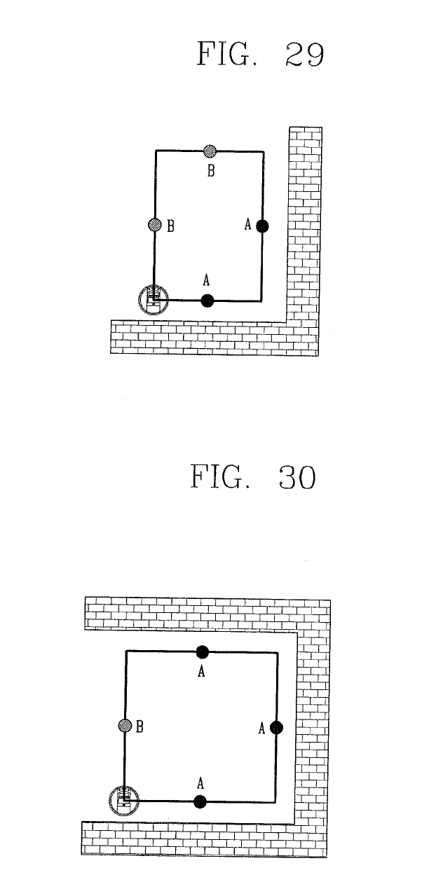

The robot cleaner then determines whether the cleaning operation has been completed. As shown in FIGS. 27 to 30, the controller 200 may determine whether the cleaning operation has been completed, according to a state change of a node associated with each sector and by setting a cleaning state at each node. The nodes may be categorized into, for example, a wall surface node (A), a loop node (B), or an island node (C) according to whether a neighboring sector is a wall surface, a sector adjacent to a wall surface, or an island type of sector.

The position recognition device 110 may include one or more distance sensors that recognize a position of the robot cleaner within the cleaning region. The position recognition device 110 may be at least one of an acceleration sensor for recognizing a speed and a position, an encoder for detecting a speed by being connected to a wheel motor which drives wheels of the robot cleaner, a gyro sensor for detecting a rotation speed of the robot cleaner, or other type of device as appropriate.

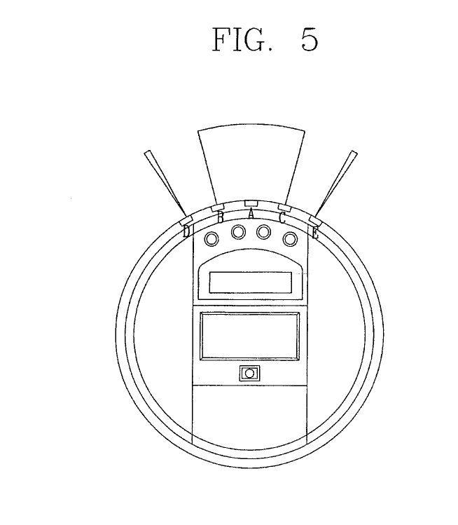

In the exemplary distance sensor shown in FIG. 5, ‘A’ indicates a Position Sensitive Detector (PSD) sensor, ‘B’ and ‘C’ indicate a supersonic wave sensor transmitter, and ‘D’ and ‘E’ indicate a supersonic wave sensor receiver. A distance detected by the PSD sensor and the supersonic wave sensor may be approximately 30 cm. FIG. 5 shows a robot cleaner employing a PSD sensor and a supersonic wave sensor as a distance sensor. However, the robot cleaner may adopt other type(s) of distance sensor(s). The robot cleaner recognizes its position by using the PSD sensor or the supersonic wave sensor, or by using a combination of thereof.

The controller 200 determines a sector type, and sets a sector reference point and a sector size. The controller 200 sets the sector size based on an initial sector size, and an overlapping margin with a neighboring sector.

The robot cleaner as embodied and broadly described herein may also include an obstacle detection device 120 configured to detect a nearby obstacle so that the controller 200 may determine a sector type according to an initial sector size and a detected obstacle.

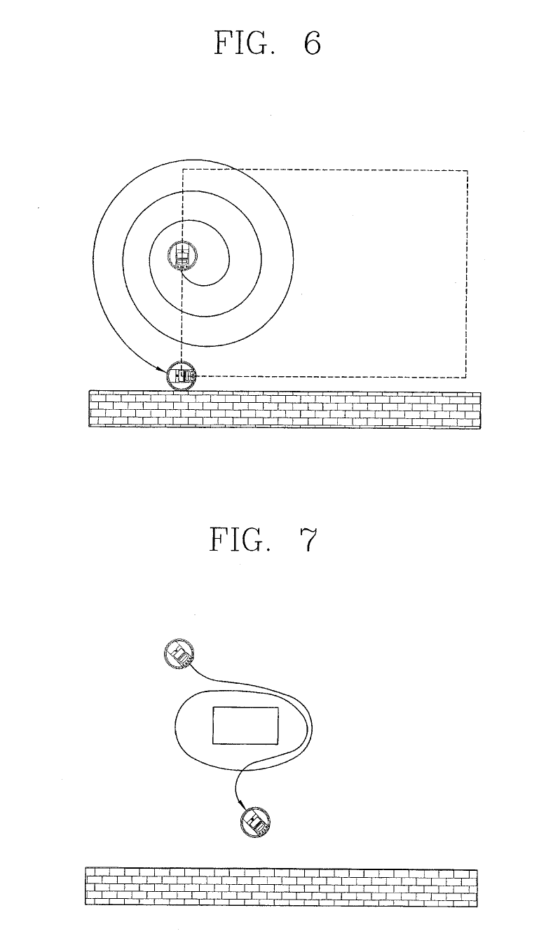

An operation in which a robot cleaner as embodied and broadly described herein searches for a wall surface will be explained with reference to FIGS. 6 to 8. FIG. 6 illustrates a spiral approach to a wall surface in which the controller 200 sets an initial sector by setting an angle of a wall surface to which the robot cleaner has approached as ‘0°’.

FIG. 7 illustrates a search for a wall surface while avoiding a small obstacle which has been detected by the robot cleaner. If a moving path along the detected obstacle does not exceed a predetermined distance, the obstacle is determined to be an obstacle rather than a wall surface, and a wall surface is searched for again. That is, the robot cleaner searches for a wall surface while avoiding an obstacle based on an accumulated rotation angle. If the robot cleaner can approach an obstacle and move straight a predetermined distance along the obstacle, the controller 200 determines the obstacle to be a wall surface.

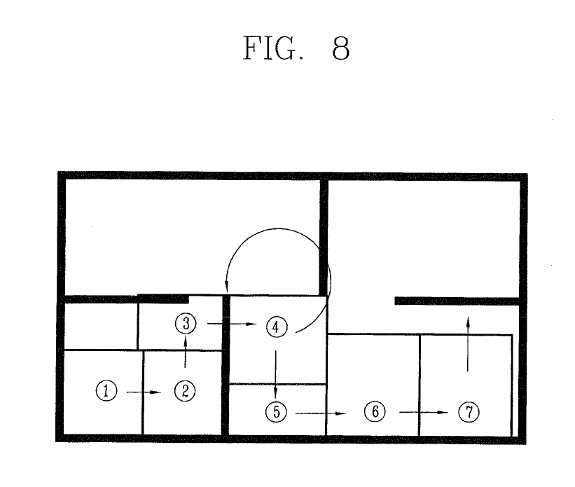

FIG. 8 illustrates an operation for generating a sector, by moving counterclockwise along a wall surface after searching for the wall surface. The controller 200 sequentially generates and cleans a plurality of sectors, and continues to move.

The robot cleaner including the obstacle detection device 120 may also be configured to detect an obstacle within the cleaning region, and the storage device 300 may be configured to store therein at least one of obstacle information, position information and sector information. The robot cleaner as embodied and broadly described herein may also include an output device 700 configured to output at least one of the obstacle information, the position information and the sector information, and an input device 600 having one or more buttons and configured to directly receive a control command.

The controller 200 extracts a predetermined number of moving points collected within a predetermined period, and calculates the moving path based on the moving points. The controller 200 calculates a gradient of an initial moving path by connecting the predetermined number of moving points to each other, and calculates a gradient change of the moving path based on a position of a next moving point and the gradient of the initial moving path.

A user may directly input a control command to the robot cleaner through the input device 600. Alternatively, the user may input a command indicating output of information stored in the storage device 300, such as information on an obstacle position or information on a cleaning region, or information detected by the obstacle detection device 110, or information recognized by the position recognition device 120. The input device 600 may include at least one of an OK button, a set button for inputting a command to be set, a reset button for inputting a command to be reset, a deletion button, a cleaning start button and a stop button. The OK button may be used to input a command for checking position information such as an obstacle position or a robot cleaner position, a cleaning region, a plurality of sectors, or a cleaning map.

The obstacle detection device 120 detects an obstacle near the robot cleaner while moving within a cleaning region, or while performing a cleaning operation. The obstacle detection device 120, may be, for example, an infra-RED sensor, a supersonic wave sensor, a radio frequency (RF) sensor, a bumper, and the like.

The storage device 300 stores therein obstacle-related information such as a position of an obstacle detected by the obstacle detection device 120 while the robot cleaner moves. The storage device 300 may be a non-volatile memory (NVM, NVRAM) for maintaining information stored therein even if power is not supplied thereto, and may include a ROM, a flash memory, a magnetic computer memory (e.g., a hard disc, a disc drive, a magnetic tape), an optical disc drive, and the like. Also, the non-volatile memory may include a magnetic RAM, a PRAM, etc. as well as a punch card and a paper tape. The storage device 300 may also store therein records related to movement of the robot cleaner within the cleaning region the cleaning region, and the plurality of sectors.

The output device 700 outputs information stored in the storage device 300, such as information on an obstacle or information on a cleaning region, information detected by the obstacle detection device 110, information recognized by the position recognition device 120, position information compensated through the controller 200, etc. The output device 700 may also display information indicating a current state of each component of the robot cleaner, a current cleaning state, and other such information. The output device 700 may be, for example, a Light Emitting Diode (LED), a Liquid Crystal Display (LCD), a Plasma Display Panel (PDP), an Organic Light Emitting Diode (OLED) or the like. The input device 600 and the output device 700 may be implemented in the form of, for example, a touch screen for input and output.

The robot cleaner may also include a cleaning device equipped with a suction motor configured to suck air therein, and a dust collection means, thereby sucking dust/foreign materials into the cleaner for collection.

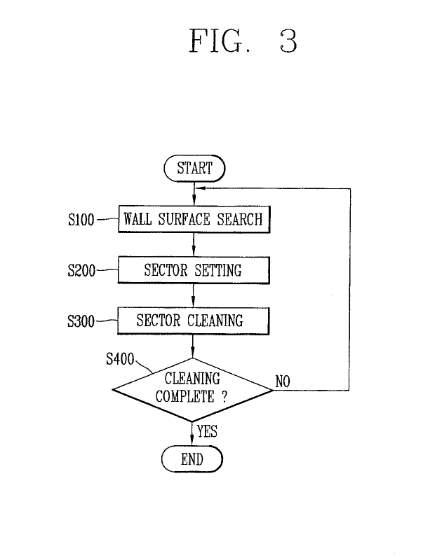

Referring to FIG. 3, a method of controlling a robot cleaner as embodied and broadly described herein may include a wall surface search step (S100) including recognizing a position of the robot cleaner and searching for a cleaning region along a wall surface, a sector setting step (S200) including setting a plurality of sectors in the cleaning region, and a sector cleaning step (S300) including cleaning the sectors. The robot cleaner cleans the entire cleaning region by repeatedly performing the steps (S100˜S300).

The wall surface search step (S100) may include detecting an obstacle within the cleaning region, and determining that the detected obstacle is a wall surface if the robot cleaner can move straight along the detected obstacle more than a predetermined distance.

The wall surface search step (S100) will be explained with reference to FIGS. 6 to 8. FIG. 6 shows a spiral type approach to a wall surface in which an initial sector is set by setting an angle of a wall surface to which the robot cleaner has approached as ‘0°’.

FIG. 7 shows a process to search for a wall surface while avoiding a small obstacle. More specifically, when an obstacle has been detected by the obstacle detection device 120, the controller 200 determines a size of the obstacle. If a moving path along the detected obstacle is not greater than a predetermined distance, the controller 200 determines that the detected obstacle is an obstacle, and not a wall surface. Then, the controller 200 searches for a wall surface again. That is, the robot cleaner searches for a wall surface while avoiding the detected obstacle based on an accumulated rotation angle. If the robot cleaner can approach the detected obstacle and move straight along the detected obstacle for a predetermined distance, the controller 200 determines that the detected obstacle is a wall surface.

FIG. 8 illustrates an operation for generating sectors by moving counterclockwise moving along a wall surface after searching for the wall surface. The robot cleaner sequentially generates and cleans a plurality of sectors, and continues to move.

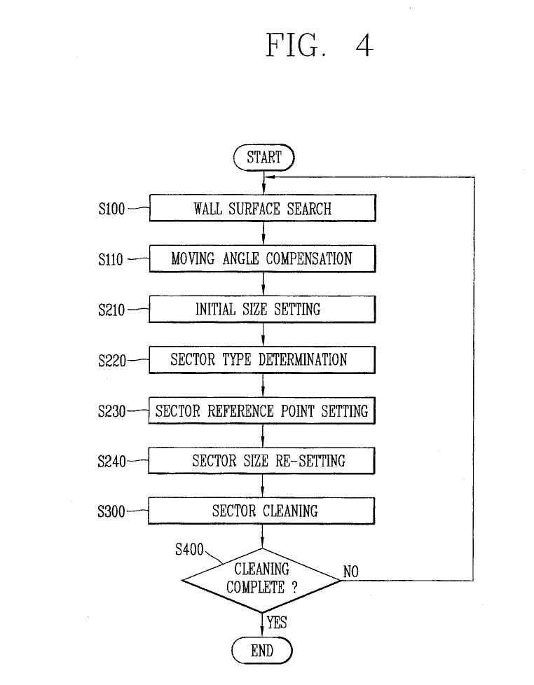

Referring to FIG. 4, a method of controlling a robot cleaner in accordance with an embodiment as broadly described herein may include a moving angle compensation step (S110) including calculating a moving path of the robot cleaner and compensating for a moving angle of the robot cleaner based on the calculated moving path. The moving angle compensation step (S110) may also include extracting moving points collected during a predetermined period and calculating the moving path based on the moving points. In certain embodiments, the moving angle compensation step (S110) may also include calculating a gradient of an initial moving path by connecting the moving points to each other, and calculating a gradient change of the moving path based on a position of a next moving point and the gradient of the initial moving path.

The moving angle compensation step (S110) will be explained with reference to FIGS. 9 and 10. FIG. 9 illustrates an operation for calculating a moving path while the robot cleaner performs the wall surface search step (S100). That is, the robot cleaner extracts a finite number of moving points P at a predetermined interval Pᵢₙₜ while searching for a wall surface. Then, the robot cleaner calculates an initial moving path B_{w} based on the moving points P. The robot cleaner calculates a gradient of the initial moving path, and stores the moving points and the moving path. If a new moving point is added, the robot cleaner calculates the moving path again. The robot cleaner determines whether to include the newly added moving point to the previous moving path, or to calculate a new moving path including the newly added moving point, based on a distance dₚ₋₁ between the newly added moving point and the previous moving path, and based on an angle θₚ₋₁ between the newly added moving point and a center point of the previous moving path. The robot cleaner utilizes a gradient of the calculated moving path as a reference angle for compensating for a moving angle.

FIG. 10 illustrates an operation for compensating for a moving angle based on the moving path calculated in FIG. 9. If a currently calculated moving path is determined to be disposed on essentially the same line as a moving path calculated from a previous sector, the robot cleaner compensates for the currently calculated moving path into the moving path of a previous sector. Then, the robot cleaner utilizes this compensated moving path as a reference angle for compensating for a moving angle of a next sector.

Referring back to FIG. 4, the sector setting step (S200) (shown in FIG. 3) may include an initial size setting step (S210) including setting an initial sector size, a sector type determination step (S220) including determining a sector type based on the initial sector size and a detected obstacle, a sector reference point setting step (S230) including setting a sector reference point and an initial sector position based on a sector type, and a sector size resetting step (S240) including re-setting a sector size based on the initial sector size and an overlapping margin with a neighboring sector.

FIG. 11 illustrates an operation for setting a sector reference point so as to perform a cleaning operation on divided sectors. The sector reference point may be identified by two components, a position (x, y) and a direction (q), with sector boundaries defined by maximum values (S_{Xmax}, S_{ymin}) and (S_{Xmin}, S_{ymax}). FIG. 12 illustrates an operation for setting a sector size, i.e., a maximum range of a sector. An initial sector range is set based on an initial size of a current sector, i.e., a height and a width of the current sector. Then, a height and a width of the next sector is determined based on an overlapping margin with the current sector, thereby re-setting a sector size for the next sector. In certain embodiments, the overlapping margin may be preset to, for example, approximately 30 cm.

In the sector type determination step (S220), a sector type may be determined by forming a closed section by changing a moving direction while the robot cleaner moves along the wall surface, based on a maximum value of the initial size or the detected obstacle.

The sector type determination step (S220) will be explained with reference to FIGS. 13 to 19. The robot cleaner may determine a sector type based on an upper limited value at a boundary between an initial size and a maximum size of a predetermined sector while searching for a wall surface, and also or alternatively based on information on a detected obstacle. That is, the robot cleaner may determine a sector type by forming a closed section along the boundary by changing a direction when exceeding the range while searching for a wall surface. Alternatively, the robot cleaner may determine a type of a next sector by forming a closed section by changing a direction when detecting an obstacle, such as a new wall surface, within the preset range.

As shown in FIGS. 13 to 19, sector types may be categorized as, for example, an Open Type (I), a Normal Type, a Blocked Type (I), a Blocked Type (II), an Open Type (II), a Within Type, and an Island Type, respectively. Referring to FIGS. 13 to 16, if a sector size is smaller than a predetermined reference value, the sector type may also be considered a small type. In certain circumstances, a small type sector may not undergo a cleaning operation due to its small size or because it has already been cleaned.

In the sector reference point setting step (S230), a reference point of an initial sector is set by searching for the wall surface, and a reference point of a next sector is set according to a change in sector type, the reference point of the next sector including a position and a moving direction of the robot cleaner.

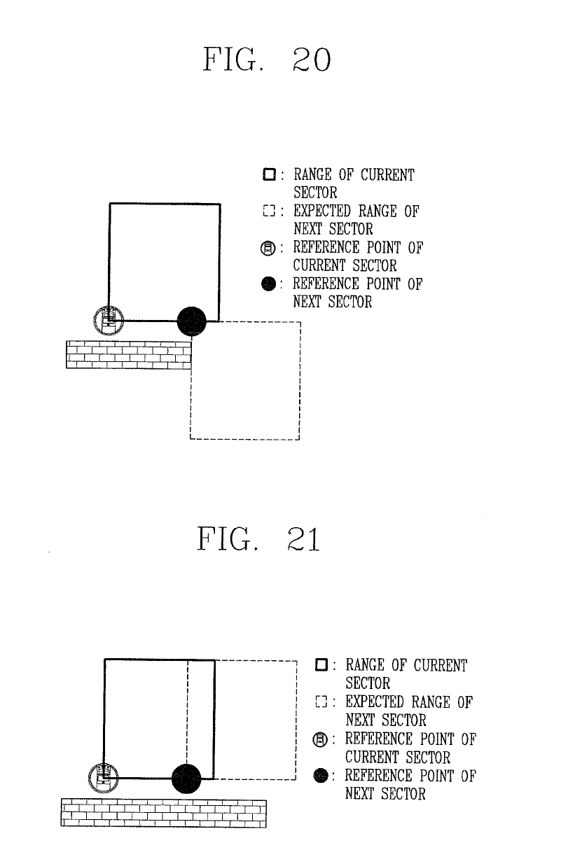

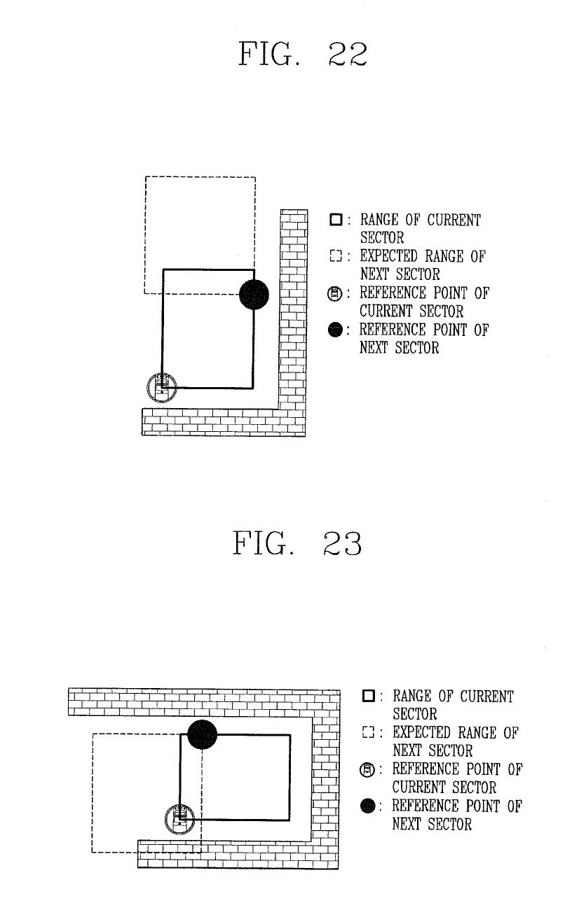

The sector reference point setting step (S230) will be explained with reference to FIGS. 20 to 23. As shown in FIG. 20, if, for example, the current sector has an open type or a small open type, the robot cleaner sets a direction angle of a reference point of the next sector by subtracting 90° from a direction angle of a reference point of the current sector. As shown in FIG. 21, if the current sector has a normal type or a small normal type, the robot cleaner sets the direction angle of the reference point of the next sector to be the same as that of the current sector. As shown in FIG. 22, if the current sector has a blocked type (I) or a small blocked type (I), the robot cleaner sets the direction angle of the reference point of the next sector by adding 90° to the direction angle of the reference point of the current sector. As shown in FIG. 23, if the current sector has a blocked type (II) or a small blocked type (II), the robot cleaner sets the direction angle of the reference point of the next sector by adding 180° to the direction angle of the reference point of the current sector.

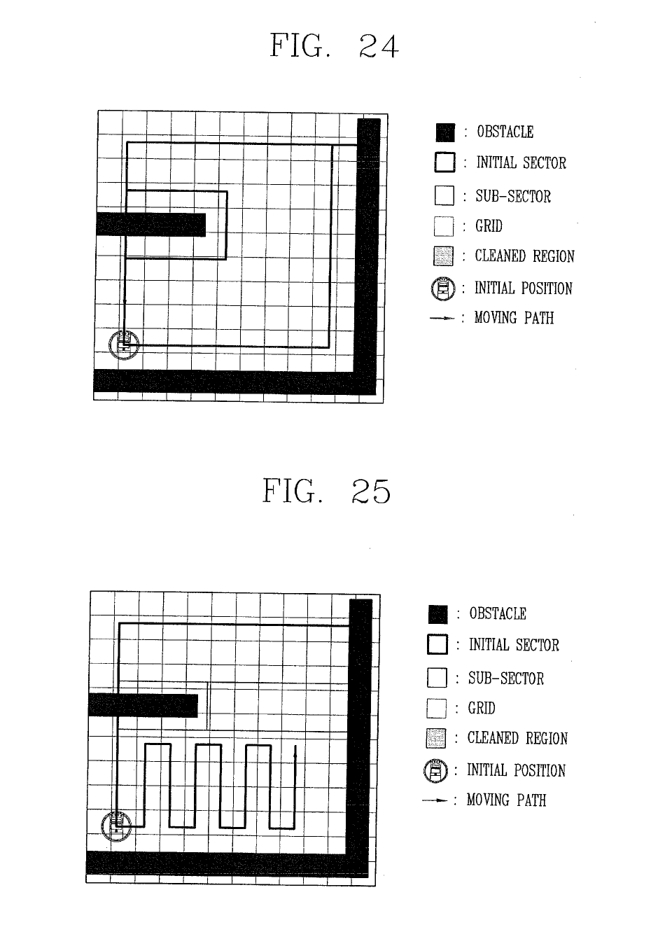

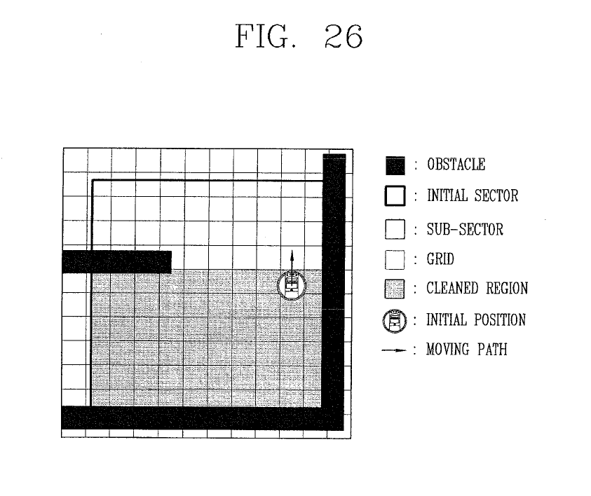

The sector cleaning step (S300) will be explained with reference to FIGS. 24 to 26. FIG. 24 illustrates an operation for determining a cleaning region inside a sector by moving to an outer periphery of the sector, and FIG. 25 illustrates an operation for dividing a polygonal sector into a plurality of rectangular sub-sectors. The robot cleaner may clean the sub-sectors using a cleaning pattern such as, for example, a zigzag method as described above. FIG. 26 illustrates an operation for searching for a sector that has not yet been cleaned by searching for a neighboring sector from the current position. More specifically, FIG. 26 illustrates an operation for searching for a nearest sector that has not yet been cleaned by using a Constrained Inverse Distance Transform. Upon completion of cleaning the current sector, the robot cleaner moves to a starting point of a neighboring sector, i.e., a reference point of the next sector, and starts to clean the next sector.

In certain embodiments, the method of controlling a robot cleaner as embodied and broadly described herein may also include storing information on at least one of a position of a detected obstacle, a position of the robot cleaner, and a cleaning region including the plurality of sectors.

The method of controlling a robot cleaner may also include a cleaning completion determination step (S400). FIGS. 27 to 30 each show an initial setting of a node according to a particular sector type. As shown in FIGS. 27 to 30, the node may be categorized as a wall surface node (A), a loop node (B), or an island node (C) based on whether a neighboring sector is a wall surface, a sector adjacent to a wall surface, or an island type of sector. Each node may be set as a cleaned state or a non-cleaned state based on whether or not a neighboring sector has been completely cleaned. Checking whether a cleaning operation has been completed or not at each node may be done by determining whether a cleaning operation has been completed at a loop node, and by determining whether a non-cleaned region at an island node exists. If all regions at the island node are completely cleaned, the cleaning operation is ended. An order for the cleaning completion determination step may be adjusted based on a particular cleaning environment of a cleaning region or a user's request.

As aforementioned, in a robot cleaner and associated control method as embodied and broadly described herein, once the robot cleaner is disposed on a cleaning region, the robot cleaner searches for a wall surface. While moving along the wall surface, the robot cleaner generates sectors having a predetermined size, and determines types of the sectors based on peripheral conditions. Then, the robot cleaner performs a cleaning operation in a zigzag pattern manner by dividing the generated sector into sub-sectors, and sequentially moves from one sector to the next to perform cleaning. More specifically, after cleaning a sector, the robot cleaner approaches the wall surface again, and sets a next sector to be cleaned moving along the wall surface, thereby performing a cleaning operation. A gradient of each moving path of the robot cleaner may be stored while the robot cleaner moves along the wall surface and the respective gradients of the robot cleaner may be compared with each other to reposition of the robot cleaner as appropriate. This may prevent increases in position error as the robot cleaner cleans the entire cleaning region.

As aforementioned, in a robot cleaner and associated control method as embodied and broadly described herein, when performing a cleaning operation in a relatively large space, such as, for example, an entire house, the robot cleaner may automatically compensate for a moving angle and a position using an appropriate sensor and a control algorithm. Accordingly, position error may be reduced, a cleaning region may be effectively identified as a region to be cleaned or a region having already been cleaned, and cleaning performance and efficiency may be maintained or enhanced.

A robot cleaner is provided that is capable of having a high cleaning performance and/or high cleaning efficiency when cleaning a wide region such as an entire region inside a house, and a controlling method of the same.

A robot cleaner is provided that is capable of performing a cleaning operation according to each sector by dividing a cleaning region into a plurality of sectors on the basis of a predetermined area or environmental condition, with moving on an entire region inside a house along a wall surface, and a controlling method of the same.

A robot cleaner is provided that is capable of calculating a moving path through a cheap sensor and a control algorithm, capable of reducing a position error by compensating for a moving angle, and capable of efficiently performing wall surface search, and capable of effectively determining whether a cleaning region is a region having been cleaned or a region to be cleaned, and a controlling method of the same.

A robot cleaner as embodied and broadly described herein may include a power unit having a chargeable power supply means, and configured to supply power; a driving unit configured to move by driving one or more wheels; a position recognition unit having one or more distance sensors, and configured to recognize a position of the robot cleaner within a cleaning region; and a control unit configured to compensate for the position by calculating a moving path, and configured to perform a cleaning operation by setting sectors with moving on the cleaning region.

In certain embodiments, the control unit may include a moving path calculation module configured to extract moving points formed according to a predetermined period, and configured to calculate a moving path by connecting the moving points to each other. The control unit may also include a moving path gradient calculation module configured to calculate a gradient of an initial moving path by connecting the predetermined number of moving points to each other, and to calculate a gradient change of the moving path based on a position of a next moving point and the gradient of the initial moving path. The control unit may also include a moving angle compensation module configured to compensate for a moving angle of the robot cleaner based on changes of the gradient of the moving path.

In certain embodiments, the control unit may include a sector size setting module configured to set a sector size based on an initial sector size and an overlapping margin with a neighboring sector. The control unit may also include a sector type determination module configured to determine a sector type according to an initial sector size and an obstacle within the cleaning region. The control unit may also include a sector reference point setting module configured to set a sector reference point, an initial sector position according to a sector type.

The robot cleaner may also include an obstacle detection unit configured to detect the obstacle, a storage unit configured to store therein at least one of obstacle information, position information and sector information, an output unit configured to output at least one of the obstacle information, the position information and the sector information, and an input unit having one or more buttons and configured to directly receive a control command.

A controlling method of a robot cleaner as embodied and broadly described herein may include a wall surface search step of recognizing a position of the robot cleaner, and searching for a cleaning region along a wall surface; a sector setting step of setting sectors with moving on the cleaning region; a sector cleaning step of cleaning the sectors; a moving path calculation step of calculating a moving path of the robot cleaner; and a position compensation step of compensating for the position of the robot cleaner based on the moving path.

The moving path calculation step may include extracting moving points formed according to a predetermined period, and calculating the moving path by connecting the moving points to each other.

The method may also include a moving angle compensation step of compensating for a moving angle of the robot angle according to the moving path. The moving angle compensation step may include calculating a gradient of an initial moving path by connecting the predetermined number of moving points to each other, and calculating a gradient change of the moving path based on a position of a next moving point and the gradient of the initial moving path, wherein the moving angle is compensated based on the gradient change of the moving path.

The wall surface search step may include detecting an obstacle within the cleaning region, and determining the obstacle as a wall surface when the robot cleaner can straight move by a distance more than a predetermined distance along the obstacle.

The sector setting step may include an initial size setting step of setting an initial sector size, a sector type determination step of determining a sector type according to the initial sector size and the obstacle, a sector reference point setting step of setting a sector reference point, an initial sector position according to a sector type, and a sector size resetting step of re-setting a sector size based on the initial sector size and an overlapping margin with a neighboring sector.

In the sector type determination step, a sector type may be determined by forming a closed section by changing a moving direction while moving along the wall surface, according to a maximum value of the initial size or the obstacle.

In the sector reference point setting step, a reference point of an initial sector may be set by searching for the wall surface, and a reference point of a next sector may be set according to change of a sector type, the reference point of the next sector including a position and a moving direction of the robot cleaner.

In the robot cleaner and the controlling method as embodied and broadly described herein, a moving angle may be autonomously compensated through a cheap sensor and a control algorithm in case of cleaning a wide space, e.g., an entire region inside a house.

In the robot cleaner and the controlling method as embodied and broadly described herein, a moving angle may be compensated through a cheap sensor and a control algorithm, thereby reducing a position error and effectively determining a cleaning region as a region to be cleaned or a region having been cleaned.

In the robot cleaner and the controlling method as embodied and broadly described herein, a moving direction (i.e., moving angle) may be compensated while the robot cleaner moves, thereby reducing a position error. Furthermore, a wall surface may be effectively searched by effectively searching for a cleaning region, a cleaning region may be effectively determined as a region to be cleaned or a region having been cleaned, and a high cleaning performance and high cleaning efficiency may be maintained.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A robot cleaner, comprising:
a power supply that supplies power to the robot cleaner;
a driver that drives one or more wheels to move the robot cleaner;
a position recognition device including one or more distance sensors, wherein the position recognition device recognizes a position of the robot cleaner within a cleaning region; and
a controller that calculates a moving path of the robot cleaner and adjusts the moving path based on the recognized position, and that sets sectors within the cleaning region to perform a cleaning operation along the adjusted moving path.

2. The robot cleaner of claim 1, wherein the controller comprises a moving path calculation module that extracts moving points collected within a predetermined period, and that connects the moving points to calculate the moving path.

3. The robot cleaner of claim 2, wherein the controller further comprises a moving path gradient calculation module that calculates a gradient of an initial moving path by connecting a predetermined number of moving points collected during the predetermined period to each other, and that calculates a gradient change of the moving path based on a position of a next moving point and the gradient of the initial moving path.

4. The robot cleaner of claim 3, wherein the controller further comprises a moving angle compensation module that compensates for a moving angle of the robot cleaner based on the gradient change of the moving path.

5. The robot cleaner of claim 1, wherein the controller comprises a sector size setting module that sets a sector size based on an initial sector size and an overlapping margin with a neighboring sector.

6. The robot cleaner of claim 5, wherein the controller further comprises a sector type determination module that determines a sector type based on an initial sector size and an obstacle detected within the cleaning region.

7. The robot cleaner of claim 6, wherein the controller further comprises a sector reference point setting module that sets a sector reference point and an initial sector position based on the determined sector type.

8. The robot cleaner of claim 6, further comprising an obstacle detection device that detects an obstacle in the cleaning region.

9. The robot cleaner of claim 8, further comprising a storage device that stores at least one of obstacle information, position information or sector information.

10. The robot cleaner of claim 8, further comprising an output device that outputs at least one of obstacle information, position information or sector information.

11. The robot cleaner of claim 1, further comprising an input device having one or more buttons and configured to directly receive a control command.

12. A controlling method of a robot cleaner, the method comprising:
searching a wall surface comprising recognizing a position of the robot cleaner, and searching for a cleaning region along a wall surface;
moving within the cleaning region and setting sectors within the cleaning region;
a sector cleaning step of cleaning the sectors;
calculating a moving path of the robot cleaner; and
compensating for the recognized position of the robot cleaner based on the calculated moving path.

13. The method of claim 12, wherein calculating the moving path comprises:
extracting moving points collected within a predetermined period; and
calculating the moving path by connecting the moving points to each other.

14. The method of claim 12, further comprising compensating for a moving angle of the robot cleaner based on the moving path.

15. The method of claim 14, wherein compensating for the moving angle comprises:
calculating a gradient of an initial moving path by connecting a predetermined number of moving points to each other; and
calculating a gradient change of the moving path based on a position of a next moving point and the gradient of the initial moving path, wherein compensating for the moving angle of the robot cleaner is based on the gradient change of the moving path.

16. The method of claim 12, wherein searching the wall surface comprises:
detecting an obstacle within the cleaning region; and
determining that the obstacle is a wall surface when a distance moved by the robot cleaner along the obstacle is greater than a predetermined distance.

17. The method of claim 16, wherein setting sectors within the cleaning region comprises:
setting an initial sector size;
determining a sector type based on the initial sector size and the detected obstacle;
setting a sector reference point and an initial sector position based on the determined sector type; and
re-setting a sector size based on the initial sector size and an overlapping margin with a neighboring sector.

18. The method of claim 17, wherein determining the sector type comprises forming a closed section by changing a moving direction of the robot cleaner while moving along the wall surface based on a maximum value of the initial sector size or the detected obstacle.

19. The method of claim 17, wherein setting the sector reference point comprises setting, a reference point of an initial sector by searching for the wall surface, and setting a reference point of a next sector based on a change in a sector type, the reference point of the next sector including a position and a moving direction of the robot cleaner.

20. A robot cleaner, comprising:
a power supply that supplies power to the robot cleaner;
a driver that moves the robot cleaner; and
a controller that controls operation of the robot cleaner, the controller comprising:
a moving path calculation module that calculates a moving path of the robot cleaner based on a position of the robot cleaner within a cleaning region and a plurality of points collected as the robot cleaner moves within the cleaning region;
a moving path gradient calculation module that calculates a gradient of the moving path and changes in gradient of the moving path;
a moving angle compensation module that adjusts a moving angle of the robot cleaner based on changes in gradient of the moving path calculated by the moving path gradient calculation module; and
a sector size setting module that sets sector size for a plurality of sectors within the cleaning region.

21. The robot cleaner of claim 20, further comprising:
a position recognition device that determines a position of the robot cleaner within the cleaning region based on a signal from one or more first sensors; and
an obstacle detection device that detects an obstacle within the cleaning region based on a signal from at least one second sensor.

22. The robot cleaner of claim 21, wherein the moving path calculation module connects the plurality of points to calculate the moving path, and the moving path gradient calculation module calculates changes in gradient based on the calculated gradient of a current moving path and a position of a point subsequent to the current moving path.

23. The robot cleaner of claim 21, wherein the sector size setting module sets sector size based on an initial sector size and an overlapping margin with a neighboring sector, and wherein the controller further comprises:
a sector type determination module that determines a sector type based on the initial sector size and an obstacle detected within the cleaning region; and
a sector reference point setting module that sets a sector reference point and an initial sector position based on the determined sector type.
